(19) United States
(12) Patent Application Publication
(10) Pub. No.: US 2025/0020261 A1
(43) Pub. Date: Jan. 16, 2025

(54) STEEL CLADDING SYSTEM AGAINST ABRASIVE WEAR OF EASY INSTALLATION AND MAINTENANCE

(71) Applicant: TERNIUM ARGENTINA S.A., Ciudad Autónoma de Buenos Aires (AR)

(72) Inventors: Roberto Gerardo BRUNA, Ciudad Autónoma de Buenos Aires (AR); Fernando Augusto ACTIS, Ciudad Autónoma de Buenos Aires (AR)

(21) Appl. No.: 18/595,986

(22) Filed: Mar. 5, 2024

(30) Foreign Application Priority Data
Jul. 14, 2023 (AR) 20230101849

(51) Int. Cl. F16L 57/06; C09J 5/06; C22C 38/02; C22C 38/04

(52) U.S. Cl. CPC F16L 57/06; C09J 5/06; C22C 38/02; C22C 38/04

(57) ABSTRACT

A cost-effective cladding system for substrates subject to abrasive wear, comprising a plurality of wear-resistant steel plates having a predetermined shape and size to better fit the protected surface, flat or curved, such as haul bodies of trucks for minerals transport, bins, ducts, conveyors and similar equipment, used in several industrial fields, for example in the transportation, mining, steelmaking, agricultural and construction industries. The wear-resistant steel plates are attached to the substrate by means of an adhesive with sufficient bonding strength against shear and peeling to maintain the steel plates in their place withstanding the impact and frictional forces. The adhesive also facilitates replacement of the wear-resistant steel plates by reducing the adhesive force by a temperature increase. The adhesive is of the type of mono-component of silane and the wear-resistant steel plates are made of steel 15B30, or any steel of similar characteristics, having a hardness above 45 HRC Rockwell C after tempering heat treatment and preferably having mainly martensitic microstructure, and optionally carbonitrided.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This patent application claims priority to Argentine Patent Application No. P20230101849, filed on Jul. 14, 2023, which is herein incorporated by reference in its entirety for all purposes.

### BACKGROUND

### Field

The present disclosure relates to a steel cladding system for protection of substrates of steel, aluminum, or other materials subject to abrasive wear, under a cost-effective approach so that said system is easy and simple to install and maintain.

One of the most important applications of the steel cladding system relates to vehicles for hauling and transportation of materials in several industrial fields, for example in the mining, steelmaking, agricultural and construction industries; however, it is evident that the disclosure is applicable to other kinds of machinery and industrial components where contact with abrasive materials causes an important wear for instance bins, ducts, conveyors, cement mixers, to name some examples.

### Description of the Related Art

One of the most used materials for fabrication of machinery and industrial components, for example, haul bodies of transport trucks, front loaders, bins, ducts or silos for materials handling is steel. Generally, the steel utilized to manufacture machinery and industrial components is selected with dimensions and characteristics of mechanical resistance, to withstand the stress caused by the weight of load under working conditions of said components; however, the steel usually employed does not offer a suitable wear resistance for abrasive materials, and after a time of operation a replacement could be required due to any progressive wear level.

It has been proposed to increase the gauge thickness of steel substrates subject to wear to extend their lifespan, but this solution entails a higher cost of said substrates and, regarding trucks for materials transportation, implies that the payload weight capacity decreases due to the higher weight of the haul bodies. Additionally, it has been proposed to use alloyed steels with higher wear resistance, but these steels present welding problems and higher costs.

There are in the market a variety of proposals to protect substrates against abrasive wear that essentially consist of cladding those zones of the substrate subject to abrasion with wear-resistant plates of steel, ceramic or polymeric materials.

The wear-resistant plates can be attached to the surface of substrates to be protected by means of welding, bolts, or rivets, but these attaching means imply perforations of structural parts of the industrial components, which frequently weaken the components and render more complex the installation and replacement of said plates.

In order to avoid perforations for bolts or rivets, U.S. Pat. No. 8,708,391 describes a cladding system with steel plates that are attached to the haul body of a truck for material transport by means of magnetic elements. This proposal, however, has the disadvantage of having a high cost and lacks a suitable stability against the impact and frictional forces exerted by the load of abrasive materials.

Regarding easy replacement of the protective cladding against abrasion, a proposal for easy withdrawal of wear-resistant plates needing replacement is described in patent application WO2022152666. The mechanism proposed to facilitate replacing wear-resistant plates comprises an expandable ejection element located between the wear-resistant plates and the surface of a truck haul body. The ejection element is expanded by means of compressed air or a hydraulic system. This proposal is complex to practice and entails a high cost.

There is still an unsatisfied need of an efficient and cost-effective system for installation of a liner of wear-resistant steel plates, which protect structural elements of machinery components and/or materials hauling vehicles, for handy installation of the steel plates forming the wear liner as well as replacement of the abrasion-worn plates.

Documents cited in this text (including the above-mentioned patent publications), and all documents cited or referred to in the herein cited documents are incorporated for reference.

### SUMMARY

In one aspect, a cladding system against abrasive wear is described. The cladding system against abrasive wear is formed by wear-resistant steel plates of predetermined shape and size to fit and be installed over the surface of substrates subject to wear by contact with abrasive materials, wherein said wear-resistant steel plates are bonded to said substrate by an adhesive, wherein said adhesive (a) maintains the wear-resistant steel plates in their position withstanding impact forces and friction caused by said contact with abrasive materials, and (b) facilitates separation of the wear-resistant steel plates from the substrate when temperature of said adhesive is raised to a level above 350° C.

In some embodiments, said temperature level is between 350° C. and 400° C. In some embodiments, said adhesive is of the kind of mono-component and based on polymers of modified silane. In some embodiments, said adhesive has a value of elongation at break (ISO 37 at a velocity of 200 mm/min) is between 230% and 260%. In some embodiments, said adhesive has a tensile strength at 100% elongation (ISO 37) between 1.1 MPa and 1.5 MPa. In some embodiments, said steel used to form the wear-resistant steel plates is 15B30 or any steel of similar characteristics.

In some embodiments, the chemical composition of said steel used to form the wear-resistant steel plates includes the following elements in the concentrations indicated as weight %:
Carbon: 0.27%-0.35%
Manganese: 0.70%-1.50%
Phosphorus: 0.030% maximum
Sulfur: 0.025% maximum
Silicon: 0.35% maximum
Boron: 0.0005%-0.0050%

In some embodiments, said steel used to form the wear-resistant steel plates has a volumetric loss below 30 mm³, according to Norm ASTM G65 and a hardness above 45 HRC Rockwell C. In some embodiments, said steel used to form the wear-resistant steel plates has a volumetric loss below 30 mm³, according to Norm ASTM G65 and a hardness above 35 HRC Rockwell C. In some embodiments, said steel used to form the wear-resistant steel plates has a plastic strain ratio higher than 0.88 and a yield strength between 1200 and 1700 MPa, an Ultimate Tensile Strength between 1400 and 2000 MPa, and an Ultimate Elongation above 4%. In some embodiments, said steel used to form the wear-resistant steel plates is mainly martensitic and tempered. In some embodiments, said steel used to form the wear-resistant steel plates is mainly martensitic, carbonitrided and tempered.

In some embodiments, said wear-resistant steel plates have a thickness between 2 mm and 4 mm. In some embodiments, the shape of said wear-resistant steel plates is rectangular having a major dimension between 100 mm and 600 mm. In some embodiments, the shape of said wear-resistant steel plates is hexagonal having a major dimension between 100 mm and 600 mm. In some embodiments, the shape of said wear-resistant steel plates is pentagonal having a major dimension between 100 mm and 600 mm. In some embodiments, the shape of said wear-resistant steel plates is triangular having a major dimension between 100 mm and 600 mm. In some embodiments, the shape of said wear-resistant steel plates is square having a major dimension between 100 mm and 600 mm. In some embodiments, said substrate is formed of or comprises steel. In some embodiments, said substrate is formed of or comprises aluminum.

### BRIEF DESCRIPTION OF THE DRAWINGS

FIG. 1 shows a schematic partial view of an embodiment of the disclosure as applied to a haul body of a truck for transport of materials, where its surface is lined with wear-resistant steel plates.

FIG. 2 shows a schematic sectioned view of another embodiment of the disclosure as applied to protection of the inner surface of a cement and/or concrete mixer vehicle, lined with wear-resistant steel plates.

FIG. 3 shows a schematic sectional cut view of a substrate protected with wear-resistant steel plates attached to said substrate by an adhesive.

FIGS. 4 A to 4 E show some shapes of wear-resistant steel plates.

FIGS. 5 A to 5 C schematically show some suggested forms of application of an adhesive to install the wear-resistant steel plates.

### DETAILED DESCRIPTION

According to the present disclosure, the wear-resistant plates are attached to the substrate to be protected against wear by means of an adhesive. Embodiments of the present disclosure provide a wear-resistant steel cladding of easy installation and also easy replacement whereby its implementation gives a number of technical and economic advantages as compared to currently known proposals.

It is therefore an object of the present disclosure to provide a cladding system against abrasive wear, comprising a plurality of wear-resistant steel plates having a predetermined shape and size to better fit and be installed on the surface of industrial components subject to wear by contact with abrasive materials. The steel plates are attached to the substrate by means of an adhesive with sufficient strength against shear and peeling to maintain the steel plates in their place withstanding the impact and frictional forces, and further, where said adhesive is capable to provide an effective adherence between said plates and said substrate. Embodiments of the disclosure also provide a method to facilitate the replacement of said steel plates when the wear level exceeds a predetermined level by reducing the adhesive force by a temperature increase.

It is another object of the disclosure to provide a steel cladding against abrasive wear where the shape and dimensions of the wear-resistant steel plates constituting said cladding can be adapted to diverse surface geometries of protectable substrates against abrasion, flat or curved, such as haul bodies of trucks for minerals transport, bins, ducts, conveyors and the like.

Other objects of the disclosure are herein pointed out or will be evident from the description thereof.

The present disclosure will be better understood with reference to detailed description of certain specific non-limiting embodiments thereof.

The following description is done in general as referred to a cladding system of steel plates resistant to abrasive wear caused, for example, on a haul body of trucks, dump trucks for transporting materials and to a cement-mixer truck, but it will be understood that embodiment of the disclosure can be adapted to other applications such as to railroad cars, bins, ducts, silos, components of mining and construction machinery and in general equipment for materials handling.

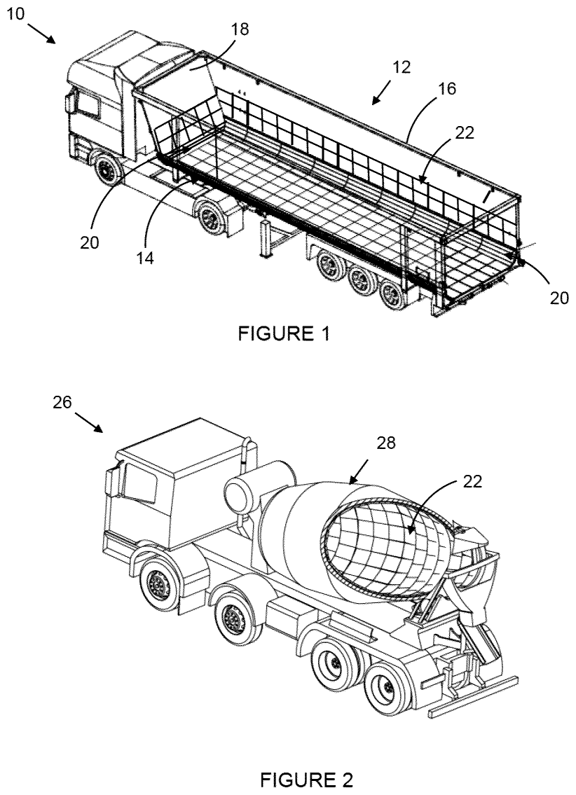

In an embodiment of the disclosure, herein described with reference to FIG. 1, numeral 10 designates in general a truck to haul materials used in the mining and construction industries, having a haul body 12 comprising a base 14, lateral walls 16, a front wall 18 and a rear wall (not fully or partially shown for the sake of clarity of this figure). Typically, there is a transition area 20, which can be inclined or curved, in the union line of base 14 with lateral walls 16 and front wall 18.

Usually, the haul body 12 is loaded by front loaders that drop the materials into the haul body thus causing abrasion and stresses on the base and walls by impact and sliding of materials during loading and unloading operations.

In some embodiments of the disclosure, the whole inner surface of the haul body 12 is lined with wear-resistant plates 22, in other embodiments of the disclosure the inner surface of the haul body 12 is lined only partially with wear-resistant steel plates 22 in those areas mostly exposed to abrasive wear. Also, the haul body 12 may be lined with wear-resistant plates 22 of different hardness and wear resistance in those areas of the surface of substrate (body, part, etc.) depending on the severity of the abrasive wear of each area.

In some embodiments of the disclosure, the wear-resistant plates 22 are laid leaving a space or gap 24 in the range of 2 to 5 mm between adjacent plates to facilitate installation and removal. Another advantage of the “chemical fastening” system using an adhesive and the separation between the plates is that a cushioning system is formed, which allows absorbing movements and vibrations transmitted by the substrate and specific impacts on the plates, without further damage.

The present disclosure offers the possibility of combining substrates 30 and wear-resistant plates 22 of different thickness, as well as selecting the areas of the substrate surface to be lined with wear-resistant plates 22 depending on the severity of the abrasive wear of each zone of the substrate to maximize the benefits/cost ratio. Preferably, the wear-resistant plates 22 have a thickness between 2 and 4 mm. It is desirable to select such thickness of the wear-resistant plates to obtain an adequate balance among cost, wear resistance and environmental protection.

With reference to FIG. 2, another embodiment of the disclosure is schematically shown as applied to protect the inner surface of a truck 26 with a cement mixer tank 28 having an inner surface constantly subject to abrasive wear. Plates 22 are adapted to the shape of the inner surface of mixer tank 28.

In an aspect of the disclosure, an embodiment is applied to any substrate having a surface subject to abrasive wear aiming to increase its operative duration, and to this end, the substrate is lined with a liner of increased resistance to abrasive wear than the wear resistance of the substrate, wherein said liner and the substrate surface are joined by means of an adhesive.

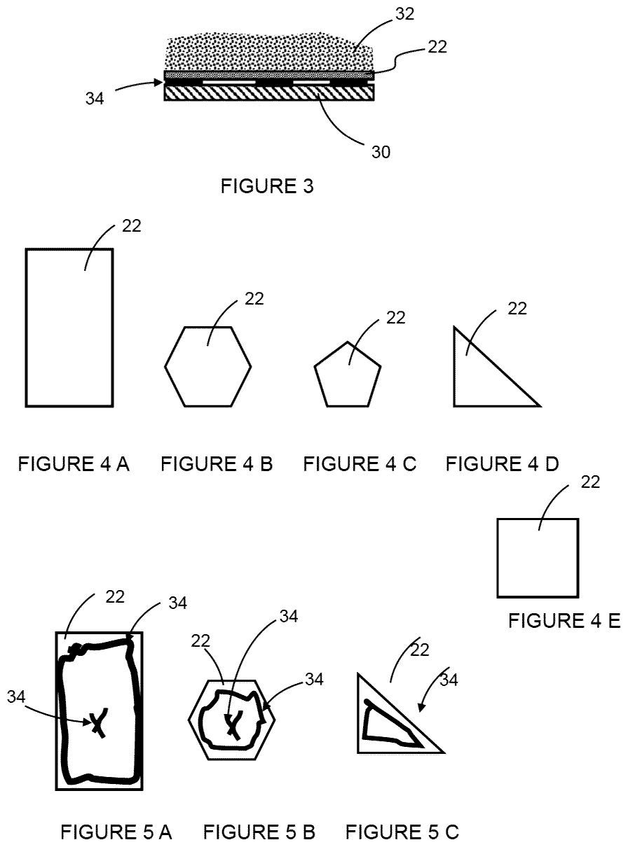

With reference to FIG. 3 schematically showing a sectional view of the cladding applied to a general substrate 30, the plates 22 cover the surface of substrate 30 and are in contact with an abrasive material 32 instead of the substrate surface. Plates 22 are joined to substrate 30 by means of an adhesive 34.

In some embodiments, the substrate that will be protected by the wear-resistant plates is formed of steel or comprises steel. In other embodiments of the disclosure, the substrate that will be protected by the wear-resistant steel plates is formed of or comprises aluminum.

Another aspect of the disclosure relates to the design of the shape and size of the steel plates so that the material for their fabrication is efficiently used and also that the plates are configured to adapt to properly cover the surface of the protected substrate and additionally the time and cost of the installation and replacement of said plates are shortened.

As schematically illustrated in FIG. 4 A, the wear-resistant plates 22 are of rectangular shape having a major dimension in the range between 100 mm and 600 mm.

As schematically illustrated in FIG. 4 B, the wear-resistant plates 22 are of hexagonal shape having a side dimension in the range between 100 mm and 600 mm.

As schematically illustrated in FIG. 4 C, the wear-resistant plates 22 are of pentagonal shape having a side dimension in the range between 100 mm and 600 mm.

As schematically illustrated in FIG. 4 D, the wear-resistant plates 22 are of triangular shape having a major dimension in the range between 100 mm and 600 mm.

As schematically illustrated in FIG. 4 E, the wear-resistant plates 22 are of square shape having a major dimension in the range between 100 mm and 600 mm.

It will be evident that the shape and dimensions of the above-mentioned plates 22 may be modified as best adapted for a particular application to properly cover the surface of the components of industrial machinery, transport vehicles, bins, etc. having diverse geometric shapes with flat and arcuate zones.

According to the disclosure, the dimensions of plates 22 are multiples of dimensions of other plates 22 so that the plates of larger dimensions can be cut, using conventional cutting methods and tools, for example, cutting with water jet, plasma, laser, forming plates of other dimensions without material waste. In this way, the inventory of plates for transport vehicles can be optimized.

Use of a suitable adhesive, instead of other joining means facilitates both the installation and replacement of plates 22. According to the disclosure, on one hand it is desirable that the plates 22 are joined with sufficient adhesion strength to withstand the stresses of impact, friction and abrasion during their use and, on the other hand, that said plates may be easily removed from the protected substrate without needing special tools.

Further, the adhesive improves the stress distribution caused by the weight and impact of the abrasive materials and avoids perforations on the substrate avoiding the use of rivets or bolts, which lead to problems of corrosion and/or weakening of the materials handling equipment. The adhesive can also provide sealing and corrosion protection to the substrate.

Normally, for ordinary adhesive uses, what is sought is that the union of the joined parts have such bonding strength as can be possibly obtained, and therefore the adhesives are selected to provide the adequate strength against shear and/or tear for as long a time as possible. This selection criterium is not adequate for an adhesive utilized to join the wear-resistant plates according to the disclosure because the wear-resistant plates, even as made of steel, are progressively worn due to the frequent and intense contact with abrasive materials and therefore, they may have to be replaced after a certain operative time when the wear level so requires.

Some common adhesives available in the market to join metals are epoxy, those based on silicon, polyurethanes, and double-faced adhesive strips, but it has been found that these adhesives are not adequate to be used in applications of the disclosure.

According to the disclosure, the adhesive to be used is mono-component based on modified silane polymers having an elongation at break (ISO 37 at a velocity of 200 mm/min) between 230% and 260% and a tensile strength at 100% elongation (ISO 37) between 1.1 MPa and 1.5 MPa, or similar characteristics. This type of adhesive provides an adequate adhesive force so that the wear-resistant plates are not detached from the surface to be protected and presents sufficient fatigue resistance that may be caused by the relative movement between such wear-resistant plates and the protected surface.

It has been found that the adhesive force of an adhesive of the above-mentioned type weakens when its temperature is above 350° C. whereby removal and replacement of the steel plates forming the wear-resistant cladding is significantly easy and simple.

The adhesive used to bond the wear-resistant plates 22 can be applied in discrete portions so that bonding of said plates and the substrate is as efficient as possible, thus saving costs of adhesive, taking into account that the plates can be replaced as easy as possible. With reference to FIGS. 5A, 5B, and 5C, in some embodiments, adhesive 34 may be placed at the periphery of the plates 22 and in the central zone of said plates 22, adapting it to the actual shape of the plates, but it will be evident that the adhesive may be applied in a variety of manners obtaining the same results.

To evaluate fitness of the kind of adequate adhesive to bond the plates 22, a fatigue test was carried out, comparing the number of cycles until breakage at the zone of a proposed adhesive (B) and other adhesive (A) commonly used to bond a variety of substrates, among which are steel and aluminum.

Determination of the fatigue tensions was made subjecting probes of steel bonded with adhesives (A and B) to a cyclic sinusoidal alternating load of constant stress using a rotating disk which, by means of a bar fixed to one end of the probe, makes it to cyclically flex with respect to the other end, which is maintained in a fixed position. Frequency of the flexions was 10 Hz and amplitude of the micro-deformations was less than 1.15 mm. The probes joined by adhesives overlapped so that the traction stress acted over the contact zone. The results of the test are shown in Table 1.

TABLE 1

| | | Thickness of | Number | Probe is |
|---|---|---|---|---|
| | | the bonding | of | broken at the |
| Kind of adhesive | Substrate | spots (mm) | cycles | bonding zone |
| Bicomponent Epoxy (A) | Steel | 2 | 1,368,000 | Yes |
| Bicomponent Epoxy (A) | Steel | 3 | 378,000 | Yes |
| Bicomponent Epoxy(A) | Steel | 3 | 270,000 | Yes |
| Bicomponent Epoxy (A) | Steel | 3 | 290,000 | Yes |
| Mono-component of silane (B) | Steel | 3 | 1,440,000 | No |
| Mono-component of silane (B) | Steel | 3 | 1,440,000 | No |
| Mono-component of silane (B) | Aluminum | 2.5 | 2,500,000 | No |

The adhesive used according to the disclosure is adhesive (B), however, other adhesives with the same or similar characteristics can be used.

When the wear level of the wear-resistant steel plates reaches a predetermined value, which can be determined, for example, visually or periodically measuring the thickness of the plates, or also by means of ultrasound, the wear-resistant steel plates are detached and replaced with new ones.

In an embodiment of the disclosure, a wear plate 22 is replaced when its thickness in any area of said plate is less than 1 mm.

To replace a wear-resistant steel plate 22, its temperature is raised above 350 C, at which the adhesive degrades and permits detachment of the plates. A flame torch can be utilized to heat the plates 22 to the desired temperature.

The wear-resistant steel plates can be detached introducing a lever at one or several points in the gaps 24 left between each plate and the adjacent plates during their installation.

Another aspect of the disclosure relates to the kind of steel utilized for fabrication of the wear-resistant plates 22.

There are several kinds of steel that resist abrasive wear where the predominant characteristic is the hardness level. The hardness of steel is mainly related to its content of carbon and of other elements such as Mn, P, Si and B. It is known that the higher the hardness, steel becomes more brittle and therefore, even if a higher hardness level would be effective to decrease wear of the steel cladding, this brings other problems due to a poor ductility, welding bonding and cutting.

According to embodiments of the disclosure, the kind of steel adequate for cladding against abrasion is steel of medium carbon content micro alloyed with bore, equivalent to steel classified as 15B30 by the Society of Automotive Engineers (SAE) or steel having similar characteristics having a hardness above 45 HRC after temper heat treatment and at the same time sufficient ductility for cutting and molding it into plates of adequate size and geometry to be conformed to the dimensions and geometry of substrates and industrial components to be protected.

It has been found that a kind of steel fit for this application, which combines the desired characteristics of hardness and ductility, is a steel having the following chemical composition:
Carbon: 0.27%-0.35%
Manganese: 0.70%-1.50%
Phosphorus: 0.030% maximum
Sulfur: 0.025% maximum
Silicon: 0.35% maximum
Boron: 0.0005%-0.0050%

According to the disclosure, the steel utilized for fabrication of the wear-resistant steel plates has a Plastic Strain Ratio higher than 0.88 and a Yield Strength between 1200 and 1700 MPa, a Ultimate Tensile Strength between 1400 and 2000 MPa, and a Ultimate Elongation above 4%.

Different steel kinds with higher or lower hardness levels for different zones of the surface of the substrate to be protected may be utilized depending on the intensity of the expected wear.

Wear resistance of steel was measured in mm³ according to Norm ASTM G65. The results are shown in Table 2. A sample probe of the steel plates is subject to abrasion of a polymer disk rotating over the surface of the sample probe against a predetermined level of force while dry sand, having a relative humidity equal or less than 0.5 weight %, and at least 95% of which has a particle size smaller than 0.0083 inches (0.212 mm) is caused to pass between said disk and the steel sample.

TABLE 2

| | | | | | Hardness |
|---|---|---|---|---|---|
| | | | Wear measured | Hardness | Rockwell |
| Steel | | Chemical | in the test | Vickers | C. |
| sample | Category | Classification | (mm³) | (HV) | (HRC) |
| 1 | Low Carbon- | <0.08% C. | 56.2 | 116 | . . . |
| | hot rolled | | | | |
| 2 | Micro-alloyed | <0.10% C. + | 38.6, 42.4, 25.9 | 156, 190, 200 | . . . |
| | hot rolled | (Nb, Ti) | | | |
| 3 | Martensitic- | 0.42% C. + | 31.8, 21.1 | 345, 446 | 35, 45 |
| | tempered | (Cr, B) | | | |
| 4 | Martensitic- | <0.15% C. + | 17.3, 15.9, 13.8 | 471, 484, 513 | 47, 48, 50 |
| | tempered | (Nb, V, Ni, Cr, B) | | | |
| 5 | Martensitic- | 0.30% C. + | 17.0, 12.6 | 544 | 52 |
| | tempered | (B) | | | |
| 6 | Martensitic- | 0.30% C + | 15.1 | 772 | 63 |
| | carbonitrided | (B) | | | |
| | & Tempered | | | | |

According to the disclosure, the steel used is tempered steel with microstructure mainly martensitic and hardness above 45 HRC, equivalent to 446 Vickers (HV), however, any other steel having similar properties can also be used.

In some embodiments of the disclosure, the wear-resistant steel plates 22 may be subject to a carbonitriding process followed by tempering, which provides a still higher level of hardness. The convenience of utilizing these processes or others of surface hardening depends on each particular application of the disclosure.

It is understood that the expressions “one embodiment”, “some embodiments” and similar wording do not refer necessarily to the same embodiment and that the feature of the disclosure referred to in this description may be combined in one or more embodiments of the disclosure.

What is claimed is:

1. A cladding system against abrasive wear, formed by wear-resistant steel plates of predetermined shape and size to fit and be installed over the surface of substrates subject to wear by contact with abrasive materials, wherein said wear-resistant steel plates are bonded to said substrate by an adhesive, wherein said adhesive (a) maintains the wear-resistant steel plates in their position withstanding impact forces and friction caused by said contact with abrasive materials, and (b) facilitates separation of the wear-resistant steel plates from the substrate when temperature of said adhesive is raised to a level above 350° C.

2. The cladding system against abrasive wear according to claim 1, wherein said temperature level is between 350° C. and 400° C.

3. The cladding system against abrasive wear according to claim 1, wherein said adhesive is of the kind of mono-component and based on polymers of modified silane.

4. The cladding system against abrasive wear according to claim 1, wherein said adhesive has a value of elongation at break (ISO 37 at a velocity of 200 mm/min) is between 230% and 260%.

5. The cladding system against abrasive wear according to claim 1, wherein said adhesive has a tensile strength at 100% elongation (ISO 37) between 1.1 MPa and 1.5 MPa.

6. The cladding system against abrasive wear according to claim 1, wherein said steel used to form the wear-resistant steel plates is 15B30 or any steel of similar characteristics.

7. The cladding system against abrasive wear according to claim 1, wherein the chemical composition of said steel used to form the wear-resistant steel plates includes the following elements in the concentrations indicated as weight %:
Carbon: 0.27%-0.35%
Manganese: 0.70%-1.50%
Phosphorus: 0.030% maximum
Sulfur: 0.025% maximum
Silicon: 0.35% maximum
Boron: 0.0005%-0.0050%.

8. The cladding system against abrasive wear according to claim 6, wherein said steel used to form the wear-resistant steel plates has a volumetric loss below 30 mm³, according to Norm ASTM G65 and a hardness above 45 HRC Rockwell C.

9. The cladding system against abrasive wear according to claim 6, wherein said steel used to form the wear-resistant steel plates has a volumetric loss below 30 mm³, according to Norm ASTM G65 and a hardness above 35 HRC Rockwell C.

10. The cladding system against abrasive wear according to claim 6, wherein said steel used to form the wear-resistant steel plates has a plastic strain ratio higher than 0.88 and a yield strength between 1200 and 1700 MPa, an Ultimate Tensile Strength between 1400 and 2000 MPa, and an Ultimate Elongation above 4%.

11. The cladding system against abrasive wear according to claim 6, wherein said steel used to form the wear-resistant steel plates is mainly martensitic and tempered.

12. The cladding system against abrasive wear according to claim 6, wherein said steel used to form the wear-resistant steel plates is mainly martensitic, carbonitrided and tempered.

13. The cladding system against abrasive wear according to claim 1, wherein said wear-resistant steel plates have a thickness between 2 mm and 4 mm.

14. The cladding system against abrasive wear according to claim 1, wherein the shape of said wear-resistant steel plates is rectangular having a major dimension between 100 mm and 600 mm.

15. The cladding system against abrasive wear according to claim 1, wherein the shape of said wear-resistant steel plates is hexagonal having a major dimension between 100 mm and 600 mm.

16. The cladding system against abrasive wear according to claim 1, wherein the shape of said wear-resistant steel plates is pentagonal having a major dimension between 100 mm and 600 mm.

17. The cladding system against abrasive wear according to claim 1, wherein the shape of said wear-resistant steel plates is triangular having a major dimension between 100 mm and 600 mm.

18. The cladding system against abrasive wear according to claim 1, wherein the shape of said wear-resistant steel plates is square having a major dimension between 100 mm and 600 mm.

19. The cladding system against abrasive wear according to claim 1, wherein said substrate is formed of or comprises steel.

20. The cladding system against abrasive wear according to claim 1, wherein said substrate is formed of or comprises aluminum.
